(19) United States
(12) Patent Application Publication
(10) Pub. No.: US 2021/0201262 A1
(43) Pub. Date: Jul. 1, 2021

(54) FREIGHT LOAD MATCHING SYSTEM

(71) Applicant: DAT Solutions, Beaverton, OR (US)

(72) Inventors: Edward Angus Damon, Portland, OR (US); Benjamin Samuel Goff, Portland, OR (US)

(21) Appl. No.: 17/137,863

(22) Filed: Dec. 30, 2020

Related U.S. Application Data
(60) Provisional application No. 62/955,552, filed on Dec. 31, 2019.

(51) Int. Cl. G06Q 10/08; G06F 16/9535; G06N 20/00; G01C 21/36

(52) U.S. Cl. CPC G06Q 10/0838; G06Q 10/08355; G01C 21/3691; G06F 16/9535; G06N 20/00; G06Q 10/08345

(57) ABSTRACT

A load matching system matches freight loads to trucking carriers based on multiple factors including carrier geo-location, load origin, load destination, carrier equipment type, information about the user, pick-up-time, drop-off-time, price elasticity, and transactional history. The system uses machine learning algorithms to provide the carrier with synthesized load information, based on past experience, current conditions and user interaction with previous load postings.

### CROSS REFERENCE TO RELATED APPLICATION

This application claims priority under 35 U.S.C. § 119, based on U.S. Provisional Application No. 62/955,552, filed Dec. 31, 2019, the disclosure of which is hereby incorporated by reference herein.

### BACKGROUND

Road-based carriers that haul freight loads over long distances need to be able to find loads to take back to their original destination or the carrier will lose revenue because the truck will be empty for one leg of the roundtrip. Systems exist to match loads with empty trucks. However, when a carrier searches existing freight matching systems on a cellphone application or an internet database, the results are typically sorted by the time they were posted and displayed to the driver. Under this scenario, a load posted most recently will appear at the top of the list for a particular search even though it may not be the most relevant to the carrier.

### BRIEF DESCRIPTION OF THE DRAWINGS

FIG. 1 is a diagram of an exemplary environment in which the systems and/or methods, described herein may be implemented;

FIG. 2 is a diagram illustrating example components of a device according to an implementation described herein;

FIG. 3 an exemplary diagram illustrating an exemplary freight load matching system of FIG. 1;

FIG. 4 is a diagram of an exemplary freight load recommender system of FIG. 3;

FIG. 5 is a flow diagram of an exemplary method for processing a new load posting according to an embodiment described herein; and

FIG. 6 is a flow diagram of an exemplary process for implementing a training model for a machine learning algorithm.

### DETAILED DESCRIPTION OF PREFERRED EMBODIMENTS

Those skilled in the art will recognize other detailed designs and methods that can be developed employing the teachings of the present invention. The examples provided here are illustrative and do not limit the scope of the invention, which is defined by the attached claims. The following detailed description refers to the accompanying drawings. The same reference numbers in different drawings may identify the same or similar elements.

According to an aspect described herein, a load matching system matches freight loads to trucking carriers based on multiple factors including carrier geo-location, load origin, load destination, carrier equipment type, information about the user (including company identification and name), pick-up-time, drop-off-time, price elasticity, and transactional history. As used herein, “carrier” includes companies operating multiple vehicles and individual contract truckers. The system uses machine learning algorithms to provide the carrier with synthesized load information, based on past experience and current conditions, that is closest the carrier's location or that can be transported on a faster route back or to a location that is closest to the carrier's starting point for the roundtrip journey. The system can also suggest a highway lane that is less costly in terms of tolls, flatter surface versus hills, etc.

When a shipper posts the salient characteristics of a load to the system, that information becomes searchable in near real time. According to an aspect described herein, a machine-learning-based system ranks and recommends shipper posts. The system prepares synthetic search results (proposed loads based on current load posting requirements by shippers) for carriers based on stored carrier information including past shipping performance. The synthetic search results are proposed to the carrier to simplify and speed the load searching process and to provide carriers with the most relevant and efficient loads without the carrier having to make that determination from among possible loads.

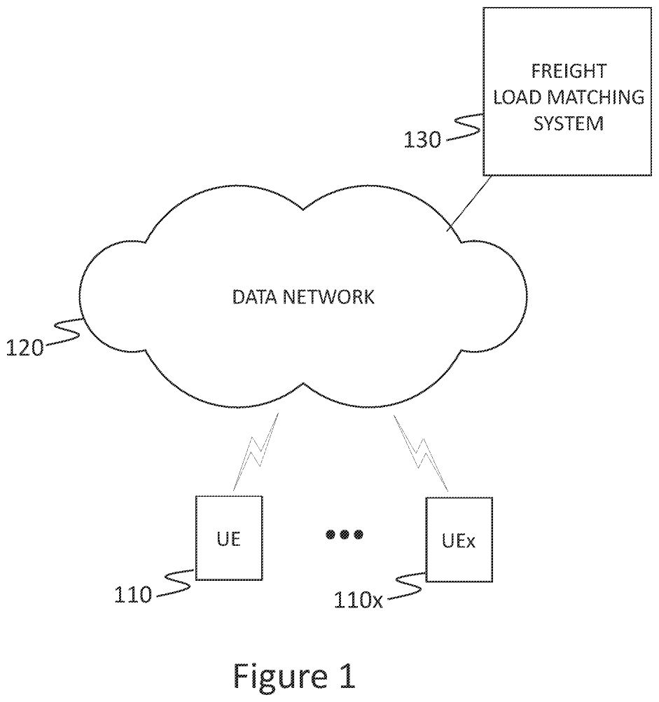

FIG. 1 is a diagram of an exemplary environment 100 in which the systems and/or methods, described herein, may be implemented. As shown in FIG. 1, environment 100 may include user equipment (UE) devices 110-1 to 110-X (referred to herein collectively as “UE devices 110” and individually as “UE device 110”), a data network 120, and a freight load matching system 130.

UE device 110 may include any device with telecommunications, telematics, and or location-determining capabilities. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); an in-vehicle communication system, a laptop computer, a tablet computer, or another type of portable computer; and/or any other type of computer device with communication capabilities and a user interface. UE device 110 may include capabilities for voice communication, mobile broadband services (e.g., video streaming, real-time gaming, premium Internet access etc.), best effort data traffic delivery, and/or other types of capabilities. In some implementations, UE device 110 may communicate using machine-to-machine (M2M) communication, such as machine-type communication (MTC), and/or another type of M2M communication.

Data network 120 may include any combination of wired or wireless networks to enable UE devices 110 to connect to freight load matching system 130. Data network 120 may include one or multiple networks of one or multiple types and technologies. For example, data. network 120 may include a Fourth Generation (4G) or Fifth Generation (5G) radio access network (RAN), a service provider core network, a virtual private network (VPN), the Internet, an intranet, etc.

Freight load matching system 130 may include on or more devices for predicting and recommending available load postings to carriers in the manner described herein. Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

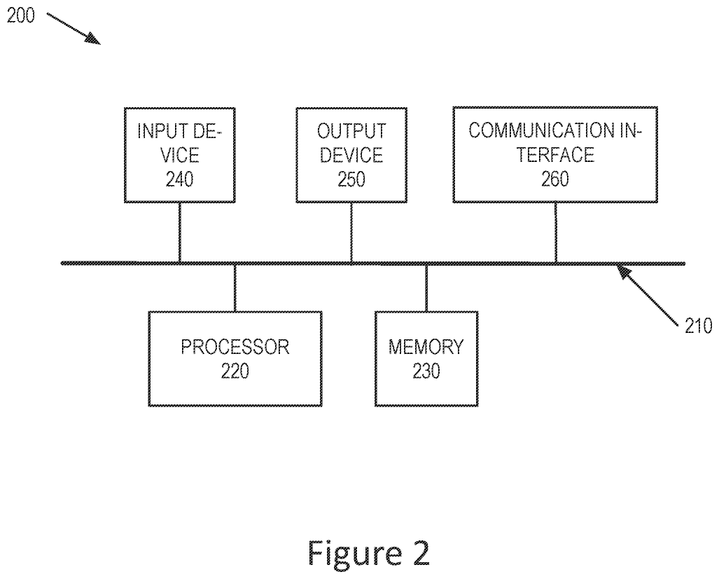

FIG. 2 is a diagram illustrating example components of a device 200 according to an implementation described herein. UE device 110, components of freight load matching system 130, and/or other components of network environment 100 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to one or more antennas/antenna arrays for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to implementing closed loop analytics feedback for a transport network. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

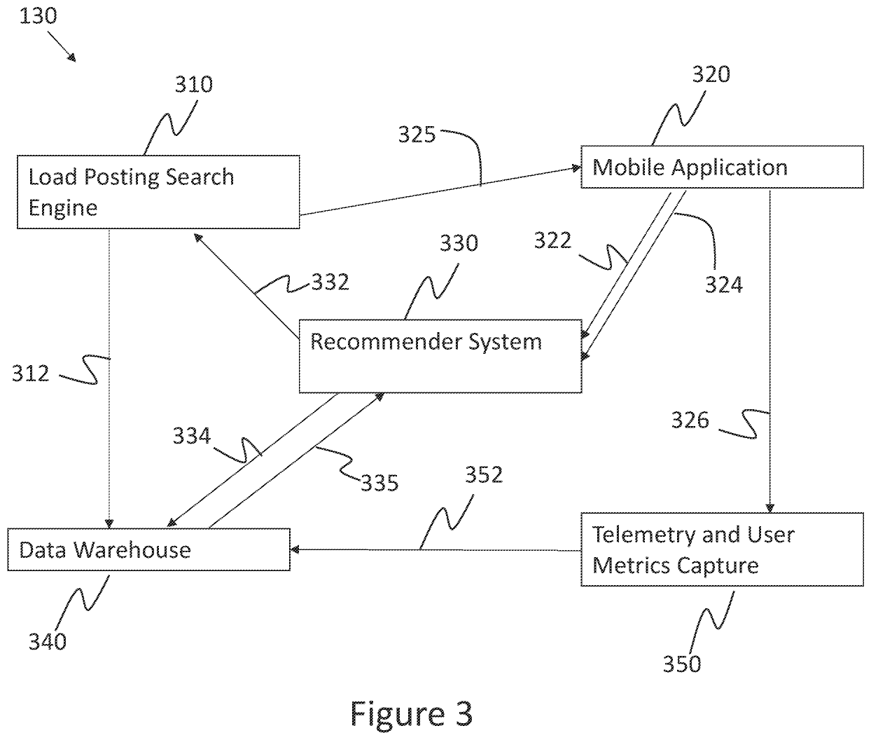

FIG. 3 is a system diagram for an exemplary freight load matching system 130 according to an aspect described herein. The load matching system 130 includes a load posting search engine 310, a user application 320, a recommender system 330, a data warehouse 340, and a telemetry and user metrics capture system 350.

As described herein, load posting search engine 310 includes a real time search engine that performs load postings using stored model attributes. The load posting search engine 310 personalizes searches based on factors including pricing and contact information about loads.

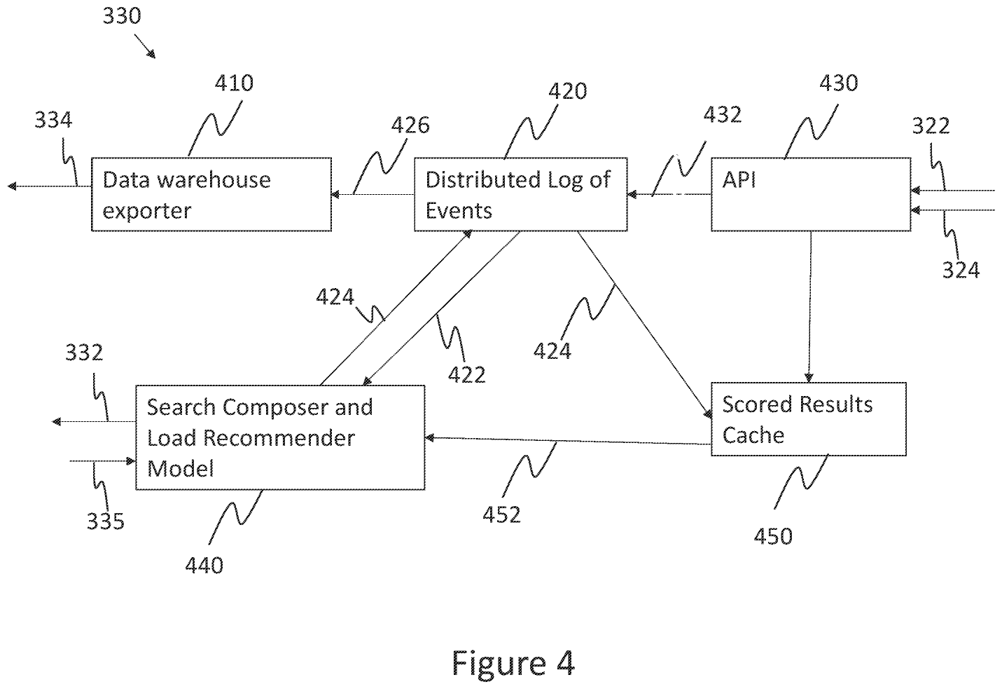

Recommender system 330 includes processing logic for training a machine learning model, which generates and recommends synthetic searches and posts. Additional details of recommender system 330 are set forth below with respect to FIG. 4.

Data warehouse 340 includes one or more physical or logical storage devices configured for use in a machine learning algorithm model training for a machine learning algorithm. Consistent with embodiments described herein, the load posting search engine 310 pushes both searches by carriers and search results 312 to data warehouse 340. The data warehouse 340 also stores load match scores 334 generated by the recommender system 330 machine learning algorithm.

Telemetry and user metrics capture system 350 includes one or more devices and/or applications for capturing information regarding user behaviors and interactions with load matching system 130. Telemetry and user metrics capture system 350 transmits user behavior information, events, and custom metrics 352 to the data warehouse 340. As described below, in relation to FIG. 2, this information, as well as location data, is used by the recommender system 330, as inputs to the machine learning algorithm to model training and validation.

User application 320 includes a web or mobile device application that: 1) allows a user to interface with recommendations and select attributes, 2) generates location data (when enabled in the device) and 3) generates user search history and behavior information. User behavior information and location data 326 from the user application 320 are sent to the telemetry and user metric capture system 350, which forwards this user information 326 to the data warehouse 340. User application 320 also allows for the user to enter details about the carrier capabilities and set preferences for a given need, including load searches or posts. In some implementations, these details 322 are sent directly to the recommender system 330.

Consistent with some implementations, user application 320 may also “score” suggested loads based on user interactions with the load postings within the application (e.g., number of user clicks on a post, time spent viewing, etc.). The user application 320 sends the scores 324 to the recommender system 330, which uses the scores in its machine learning algorithm to rate future loads for suggestions to that user and other users with similar profiles.

The recommender system 330 (detailed in FIG. 4) receives 335 new load postings, historical user preferences, pricing, user search and conversion history as well as user location data from telemetry and user metrics capture system 350 from the data warehouse 340. The recommender system 330 uses these inputs to train a machine learning model, which generates and recommends synthetic searches and posts. In response, synthetic searches 332 are presented to carriers and brokers via the load posting search engine 110 as recommended loads. The recommended loads may also be presented to individual carriers as synthetic search result 325 on the mobile application 320. Results generated by the recommender system 130 are stored in a recommender system stored results cache 450, described below to allow asynchronous look up by user carriers. The user application 320 allows a user carrier to fetch current recommendations and stored posts.

FIG. 4 is a block diagram of a recommender system 330 according to an aspect described herein. The recommender system 330 includes one or more devices that produce synthetic search results by tracking transactions the carrier has made on load boards accessible to the system, tracking searches the carrier has made, tracking clicks by any user on load posts, tracking which equipment type a carrier has used and tracking origin and destination of loads that a particular carrier has previously carried. Inputs to the recommender system 330 from the data warehouse 340 include historical user preferences, user search and conversion history, user location data, and pricing information.

As shown in FIG. 4, the recommender system 330 includes a data warehouse exporter 410; a distributed log of events 420; a web services API, which may be a representational state transfer (REST) API 430; a search composer and load recommender model 440; and a stored results cache 450.

Recommendation requests are received by the recommender system API 430 from the mobile application 320. The recommender system API 430 sends recommendation requests 432 to the distributed log of events 420. The search composer and load recommender model 440 receives recommendation requests from 422 the distributed log of events 420.

The search composer and load recommender model 440 comprises a machine learning algorithm. The machine learning algorithm generates a single score for each user for each new load posted on or retrieved by the load posting and search engine 310. The score can be a predicted match percentage for how well the user expressed preference for loads similar to this in the past. The scores 424 are sent from the search composer and load recommender model 440 to the distributed log of events. From the distributed log of events, the scores 424 are sent to the stored results cache 450. Stored results 452 are used by the machine learning algorithm in the search composer and load recommender model 440.

The machine learning algorithm can comprise supervised and/or unsupervised learning. Supervised learning uses a training data set and validation data set to learn and predict behaviors and patterns. The machine learning algorithm may include a neural network, regression analysis, random forest analysis, or gradient boosting. The training data set may include data and match results from other load matching systems or from past iterations of the presently-described load matching system. The validation data set for the machine learning algorithm may be supplied to the search composer and load recommender model 440 by the data warehouse 340. The validation data set may include information about specific loads including load origin, load destination, pick-up-time, drop-off-time, real-time route conditions, and price elasticity. The validation data set may also include information carriers who have transported loads stored in the system. Carrier information includes: carrier equipment type, carrier geo-data, and carrier transactional history. The validation data set may also include load scores based on carrier interactions with posted loads.

The machine learning algorithm of the search composer and load recommender model 440 may also or alternatively use unsupervised learning. Unsupervised learning uses mathematical methods to search for patterns in unstructured data without using a training and validation dataset. Examples of unsupervised learning include clustering, cosine similarity, and other mathematical distance related algorithms; artificial networks, Bayesian statistics, learning automata, Hidden Markov Modeling, linear classifiers, quadratic classifiers, decision trees, association rule learning, or the like. In the present invention, the unstructured dataset comprises data from the data warehouse 340, which may include pricing, route and contact information about previously delivered and currently pending loads, searches by carriers and search results, user behaviors, load location data, historical user preferences, user search and conversion history, user location data, and pricing information. The unstructured dataset may also include load match scores from the stored results cache 450. The machine learning algorithm may be configured to and learn from load match scores as a means of improving the accuracy of the system.

The search composer and load recommender model 440 sends scored load results 424 to the distributed log of events 420. Recommendation requests and load scores 426 are sent from the distributed log of events 420 to the data warehouse exporter 410. The recommender system API also fetches from the user application 320, load scores which the user application 320 sets based on user interaction with suggested (synthetic) loads. The recommender system API sends the fetched load scores 434 to the stored results cache 450 for future reference and use by the search composer and load recommender model 440.

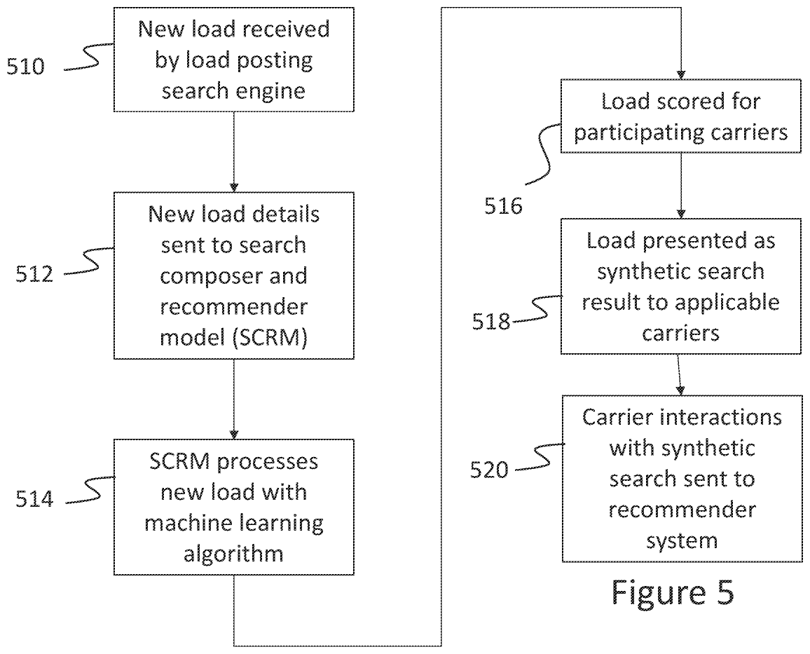

FIG. 5 is a flow diagram of an exemplary method for processing and posting to relevant carriers a new load posting by a shipper according to an aspect described herein. At 510 a new load is posted by a shipper and received by the load posting search engine 310. The load posting may be made directly to the system 130, or may be a public-posted load that the load posting search engine 310 found autonomously. At 512 the new load details, which may include, for example, load description, load origin, load destination, requested carrier equipment type, pick-up-time, and drop-off-time, are sent to the search composer and recommender model (SCRM) 440. At 514 the SCRM processes the new load details with a machine learning algorithm, which may include any of the machine learning algorithm types described herein. At 516, the machine learning algorithm assigns scores to the load for individual carriers who are participating in the load matching system 130. At 518, the load is presented on the mobile application 320 as a synthetic search result 325 to carriers for whom the load has been rated by the machine learning algorithm to be highly relevant to that carrier. For example, the machine learning algorithm may assign scores to a load from 0 to 100% relevance for a particular carrier. The carrier may manually set score level at which loads are presented to that carrier or the machine learning algorithm may set and adjust the score level. At 520, carrier interactions 324 with synthetic search results are returned to the recommender system 330.

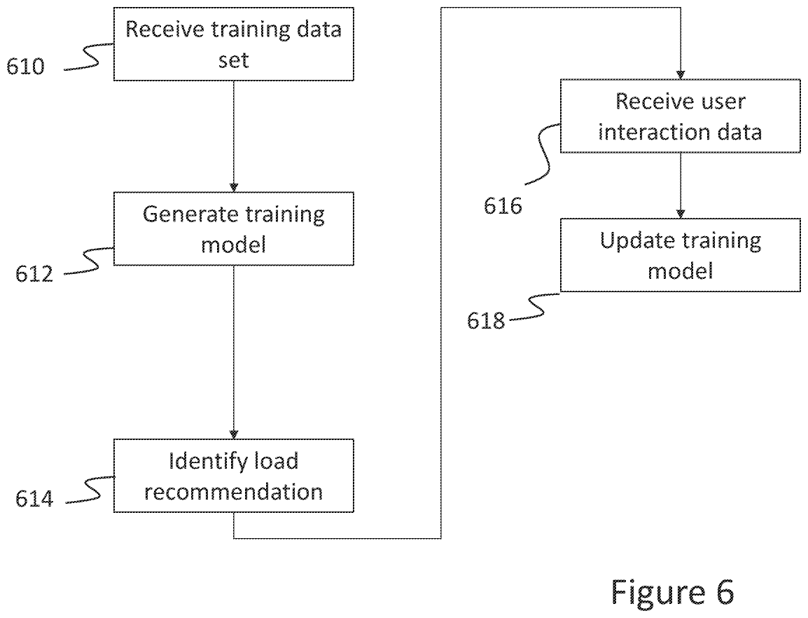

FIG. 6 is a flow diagram illustrating an exemplary process 600 for load recommendation, according to an implementation described herein. In one implementation, process 600 may be performed by the Search Composer and Load Recommender 440. In another implementation, some or all of process 600 may be performed by another device or group of devices in network environment 120.

As shown in FIG. 6, process 600 may include receiving a training data set (block 610) and generating a training model (block 612). For example, past loads selected by carriers from earlier implementations of the system and data associated with those loads may be used as training data. A training model may be extracted using a training data set. The model may provide closed form expressions that approximate the functional relations between, for example carrier interactions with load postings and load data. The model can help anticipate which loads would be selected by carriers.

Process 600 may also include identifying a load recommendation (block 614). For example, the Search Composer and Load Recommendation Model 150 may identify certain aspects of a load a relevant to a particular carrier or group of carriers. Relevance may be determined based on pricing, route, equipment type, timing or other factors.

Process 600 may also include receiving user interaction data 324 from API 430 (block 616), which collects user interactions with load posting on the mobile application 320. User interactions include not only whether a user elects to accept a load or reject one but also how may time the user clicked on that particular load, time spent with the load displayed on the mobile application 320 and instances of returning to the particular load. Process 600 may also include updating the training model based on user interactions (block 618).

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A freight load matching system comprising:
a load posting search engine, and
a load recommender system,
wherein said load posting search engine is configured to receive load data for individual freight loads to be carried, and
wherein said load recommender system is configured to assign load match scores for individual carriers to said individual freight loads, said scores being determined based on said load data and on carrier historical data.

2. The freight load matching system of claim 1, wherein said carrier historical data includes carrier pricing or performance on previous loads.

3. The freight load matching system of claim 1, wherein said load data comprises route data comprising real-time route conditions between origin and destination of said individual freight loads to be carried.

4. The freight load matching system of claim 1, wherein said load data comprises load pick-up-time and load drop-off-time.

5. The freight load matching system of claim 1, wherein said carrier historical data includes stored carrier interactions with previous postings of loads, including carrier geo-location data.

6. The freight load matching system of claim 1, wherein said load recommender system executes a supervised learning algorithm, said supervised learning algorithm operating on a validation data set comprising historic load data and carrier transactional history.

7. The freight load matching system of claim 1, wherein said load recommender system executes an unsupervised learning algorithm operating on an unstructured dataset comprising pricing and route information about previously delivered and currently pending loads.

8. The freight load matching system of claim 1, wherein said load match scores are made available to said individual carriers as synthetic search results.

9. A method of recommending freight loads to shipping carriers comprising:
receiving load data for a freight load, and
analyzing said load data against individual carrier data to produce a load match score for an individual carrier.

10. The method of recommending freight loads of claim 9, wherein said individual carrier data includes carrier pricing or performance on previous loads or carrier geo-location.

11. The method of recommending freight loads of claim 9, wherein said load data comprises route data comprising real-time route conditions between origin and destination of said individual freight loads to be carried.

12. The method of recommending freight loads of claim 9, wherein said load data comprises load pick-up-time and load drop-off-time.

13. The method of recommending freight loads of claim 9, wherein said individual carrier data includes stored carrier interactions with previous postings of loads.

14. The method of recommending freight loads of claim 9, wherein said analyzing comprises executing a supervised learning algorithm, said supervised learning algorithm operating on a validation data set comprising historic load data and carrier transactional history.

15. The method of recommending freight loads of claim 9, wherein said analyzing comprises executing an unsupervised learning algorithm operating on an unstructured dataset comprising pricing and route information about previously delivered and currently pending loads.

16. The method of recommending freight loads of claim 9, further comprising providing said load match scores to said shipping carriers as synthetic search results.

17. A non-transitory computer-readable medium storing instructions executable by one or more processors, the instructions comprising:
receiving load data for a freight load, and
analyzing said load data against individual carrier data to produce a load match score for an individual carrier.

18. The non-transitory computer-readable medium of claim 17, wherein said individual carrier data includes carrier pricing or performance on previous loads or carrier geo-location.

19. The non-transitory computer-readable medium of claim 17, wherein said load data comprises route data comprising real-time route conditions between origin and destination of said individual freight loads to be carried.

20. The non-transitory computer-readable medium of claim 17, wherein said analyzing comprises executing a supervised learning algorithm, said supervised learning algorithm operating on a validation data set comprising historic load data and carrier transactional history.
